(19) United States
(12) Patent Application Publication
(10) Pub. No.: US 2005/0091086 A1
(43) Pub. Date: Apr. 28, 2005

(54) In-route ordering of physically published material

(75) Inventor: Lee C. Moore, Rochester, NY (US)

Correspondence Address: Ortiz & Lopez, PLLC, P.O. Box 4484, Albuquerque, NM, 87196-4484, US

(73) Assignee: Xerox Corporation

(21) Appl. No.: 10/694,138

(22) Filed: Oct. 27, 2003

(51) Int. Cl. G06F 17/60

(52) U.S. Cl. 705/5

(57) ABSTRACT

A workflow for obtaining custom books or other printed materials during travel (e.g., via airline, rail, cruise ship, etc.). A traveler on an airplane, for example, would look through a catalog, select a desired publication and electronically communicate his or her order to a remote production facility near the traveler's selected destination. The order would automatically be sent to a digital book production system (e.g., print-on-demand system) near the traveler's selected destination (e.g., airport). The publication would automatically be produced and distributed to a pick-up point where it is available for pick-up by the traveler.

### FIELD OF THE INVENTION

Embodiments are generally related to on-demand-publishing. More particularly, embodiments are related to methods and system providing for the ordering, production and distribution of on-demand-publishing materials to the traveling customer market.

### BACKGROUND

Business and leisure travelers spend a substantial amount of time waiting to board, connect with, while en-route on, and while waiting to disembark from commercial conveyances. While traveling, regardless of the means of transportation used (e.g., airline, train, cruise ship, bus), travelers as a group represent a captive market for goods and services available at terminals, ports of entry and on commercial conveyances. Airports, for example, have shops that specifically cater to travelers interested in purchasing books and magazines. Such shops operate as outlets for the sale of mass-marketed novels, business books and magazines, but the selection is generally limited by availability or limited stock because of the size of the store.

The present inventor recognized the potential for distribution of published material in the traveling marketplace because of his knowledge in the field of on-demand publishing. On-demand publishing has come about in recent years because vast technological advancements in the photocopier equipment industry enable more flexible offset-quality production. Xerox Corporation, for example, offers hardware and software for the on-demand publishing marketplace. On-demand publishing technology enables publishers to print books in short run lengths on demand, at a reasonable costs. Publishers save money on warehousing, returns, and the production of intrinsically short run books (comps, review copies, sales samples, etc.) They also realize new business opportunities from out-of-print books and never-in-print books.

On-demand publishing technology now makes it easier for printing businesses to set up publishing enterprises without encumbrances associated with space and location. Print-on demand technology enables a growing number of new businesses to print and publish exactly what the customer needs, when they need it. Profitable, short run, fast turnaround work product can now be rendered in full color, highlight color and black and white and generally includes paperback coverings, photography and complex graphics.

With the necessary publishing technology now in place, the present inventor believes there is a need for use of the latest print-on demand technology to serve a marketplace that has not yet been addressed—the travel-related marketplace.

### SUMMARY OF THE INVENTION

The present invention provides methods and systems enabling business and leisure travelers to order printed publications (e.g., books, reference material, magazines, or other printed material) while in-route to their travel destinations. Methods and system(s) for automatically publishing reading material (e.g., books and magazines) ordered by a traveling customer while the customer is in route and having the publications ready for pick-up by traveling customers after the customer's arrival at their destination or a destination of their choosing will now herein be disclosed.

In accordance with features of the present invention, systems are described for automatically producing a publication ordered by a traveler while the traveler is en-route and having the publications ready for pick-up by traveling customers after the customer's arrival at their destination or a destination of their choosing. A system can include a server connected to an electronic network for receiving publication orders from travelers using electronic interface for submitting orders to the server, a database containing publications available for selection by travelers, and at least one print-on-demand system located near pick-up destinations that can be selected by travelers.

In accordance with additional features of the present invention, methods for enabling a traveler to order a printed publication from public transport facilities while traveling to the traveler's destination and for producing and distributing publications are described. Methods in accordance with preferred embodiment of the invention can include providing a traveler access to a catalogue from which publications can be selected, wherein the traveler can review ordering information about available publications, and providing an electronic interface having a network connection to “publish-on-demand facilities, said electronic interface providing a means from which the traveler can select and order the preparation of at least one publication for pick-up by the traveler at a destination also selected by the traveler, wherein the selection and ordering can occur while the customer is awaiting travel, en-route on public transportation, or preparing to disembark public transportation.

A method for automatically producing a publication ordered by a traveler while the traveler is en-route and having the publications ready for pick-up by traveling customers after the customer's arrival at their destination or a destination of their choosing can include receiving an electronic order for a publication over an electronic network from a traveler using a remote electronic interface, producing the publication using publish-on-demand system located near a destination selected by the traveler for pick-up of the publication, and distributing the publication to a pick-up facility located at the destination selected by the traveler for pick-up of the publication.

In accordance with methods of the present invention a traveling customer is provided with a catalog, which can be available while the customer is awaiting travel, while en-route, or while preparing to disembark from a vessel (e.g., a cruise ship). The catalog can be made available in printed form or through a communications network. The customer can review available reading material selections in the catalog. If the customer desires to make a publication purchase, the customer is provided an electronic interface from which to order a selection while awaiting travel, en-route, or preparing to disembark. Ordering can be provided through electronic interfaces such as kiosks and on-board communications (e.g., telephones, internet kiosks or personal wireless appliances). When completed, the order is automatically provided to and received by production facilities near the customer's scheduled or selected destination where the customer's order can be produced and then made available to the customer through on-site distribution facilities (e.g., stores or unattended kiosks) upon the customer's arrival at the destination.

### DRAWINGS

FIG. 1 illustrates a system in accordance with embodiments of the present invention that can enable travelers to order publications during travel includes an electronic interface from which a traveler can select, order and collect publications during travel;

FIG. 2 illustrates a flow diagram of methods for enabling the ordering of publications by, and distribution of publications to, a traveling customer in accordance with embodiments of the present invention;

FIG. 3 Illustrates a work flow diagram of production steps for ordering, producing and distributing a publication in accordance with embodiments of the present invention; and

FIG. 4 illustrates a flow diagram of a method for producing publication data (e.g., book blocks and book covers) is described.

### DETAIL DESCRIPTION OF THE PREFERRED EMBODIMENTS

Embodiments of the present invention can enable business and leisure travelers to order a printed publication (e.g., books, reference material, magazines, or other printed material) while in-route to their travel destinations. Methods and system for published reading material (e.g., books and magazines) ordered by a traveling customer while the customer is in route are automatically processed for publication via the novel methods and system described herein. Ordered publications are readied for pick-up by traveling customers at their final destination or a destination of their choosing while en-route to their final destination.

A practical example of how the methods and systems of the present invention can be implemented is briefly illustrated with respect to the following scenario: Customer is flying from Rochester to Chicago with an eventual connecting flight to Los Angeles. While in the air, customer finds a catalog of books in the seatback pocket located in front of customer's seat. Looking through the catalog, customer finds a recent book of interest that customer would like to read during the long flight from Chicago to LA. Customer picks up the in-flight telephone from the seat-back location in front of him and calls a toll-free number to order the book. Through the in-flight telephone keypad, customer is able to order the book and provide billing information. When customer arrives in Chicago, a copy of the book, either newly produced or already available at the destination, is waiting to be picked up by the customer.

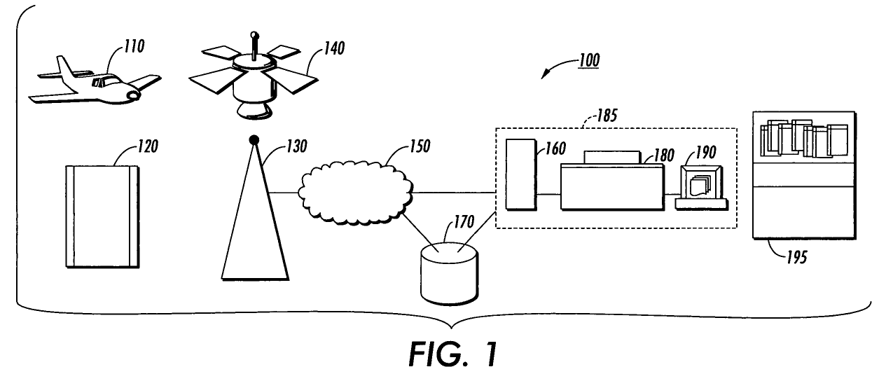

Referring to FIG. 1, a system 100 in accordance with features the present invention is illustrated. A system that would enable travelers to order publications during travel includes means for a traveler to select 120, order 160 and collect 195 publications during travel. A customer, while traveling on an airplane 110, for example, can access a catalog 120, either in printed form, located on the airplane 110, or located outside airplane 110 on databases 170. The customers order is routed to a production facility 185 located near the customer's selected pick-up point. Communication of an order from a customer is provided through a communications network, which can include wireless, satellite and the Internet 150. The order can be received by a server 160 associated with the production facility 185. Publication data related to a customer's order can be can be accessed from databases 170 through a server 160 associated with the production facility 185. A print-on-demand system 180 is available for use at the production facility 185. Publication finishing hardware 190 would also be available to and likely located with the print-on-demand system 180. A finished publication can be provided from the production facility 185 to pick-up facilities 195 located at the traveler's designated pick-up location.

It should be appreciated that the means for ordering can include a networking appliance in communication with a LAN (local area network) or wireless LAN located at a terminal or on a vessel. Ordering can also be accomplished through a traveler's handheld devices (e.g., mobile phones, PDAs). Communication in a terminal or on board a vessel would typically require Internet access, unless a private network is available.

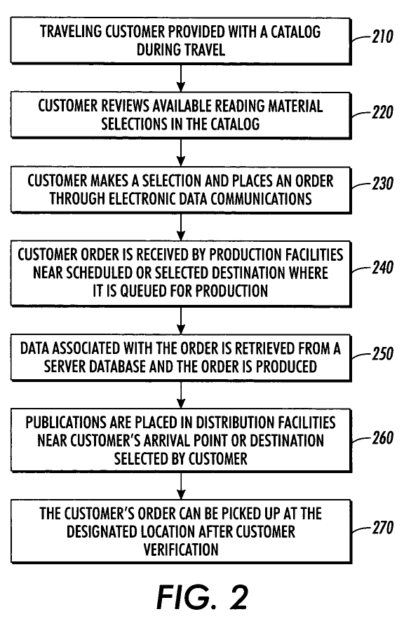

Referring to FIG. 2, a flow diagram is illustrated that provides an overview of methods for the ordering of publications by and distribution of publications to traveling customers in accordance with aspects of the present invention is illustrated. A traveling customer can be provided with a catalog during travel 210. The catalog can be made available while the customer is awaiting travel in a lobby or terminal, while physically en-route, or while preparing to disembark from a vessel (e.g., entering port and docking in a cruise ship).

A catalog can be made available in printed form or through a communications network. The customer can review publication selections available for ordering in the catalog 220. If the customer desires to make a purchase, the customer is provided a means from which to order a selection while traveling. For example, a customer can makes a selection and place an order through communications means 230, such as, kiosks, on-board communications (e.g., airplane telephones), internet kiosks or wireless appliances. Orders can be transmitted through any combination of known digital communications means.

An order can be received by production facilities near the customer's scheduled or selected destination where the order is queued for production 240 (e.g., using print-on-demand systems). Data associated with the order is retrieved from a server database and the order is produced 250. The order can then made available to the customer through on-site distribution facilities 260 (e.g., stores or unattended kiosks) upon the customer's arrival at the destination. The customers order can be picked up at the designated location after customer verification is established 270.

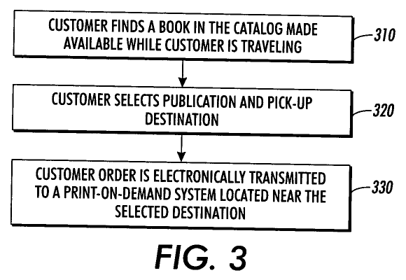

Referring to FIG. 3, Illustrates a flow diagram of production steps in accordance with an aspect of the present invention. In accordance with the step of ordering a book, a customer would finds a book in a catalog made available to the customer while the customer is traveling 310. The catalog may be located in the vehicle's cabin or in a waiting area prior to boarding the vehicle. Utilizing an electronic interface, the customer places an order from the book and selects a pick-up destination 320, which can be conducted through a telephone, internet kiosk or wireless appliance. The order can be electronically transmitted to a print-on-demand system located near the customer's selected destination 330, where the order can then be queued by a production server.

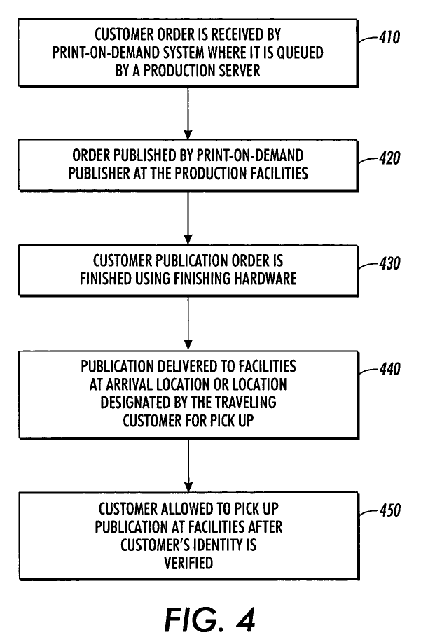

Referring to FIG. 4, a flow diagram of methods for producing publications data (e.g., book blocks and book covers) is described. Production can begin after the order is queued and data is retrieved 410. After the publication data is retrieved, publication data normally including a book block and book cover is printed 420. After data is printed, the publication is finished using finishing hardware 430, which includes binding of the book block and cover. A publication receipt can also be printed. The publication, and printed receipt, can be delivered to the arrival location designated by the traveling customer for pick up 440. The designated location can take many forms, including: a terminal-based store, a specialized vending machine, a terminal-based kiosk, a kiosk or stored location near the traveler's arrival gate. The customer can pick up the ordered publication after the customer is verified 450.

Publications that can be printed for traveling customer using the present invention include custom-ordered collections of published data including any combination of: international newspapers, professional journals, business references, magazines and novels. Published data can also include portions of publication such as selected chapters from a book, or sections and articles from newspapers or magazines. It is also a feature of the present invention if publication is made available to customers in foreign languages, which would be valuable to international travelers requiring text in their own language. When only selected potions of a publication are selected for printing (e.g., specific chapters of a book, or sections of a magazine or newspaper), a single publication can be produced that includes parts of several publications in a single, bound publication.

It is appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method for enabling a traveler to order a printed publication from public transport facilities and while traveling to the traveler's destination, comprising:
providing a traveler access to a catalogue from which publications can be selected, wherein the traveler can review ordering information about available publications;
provided an electronic interface having a network connection to publish on demand facilities, said electronic interface providing a means from which the traveler can select and order the preparation of at least one publication for pick-up by the traveler at a destination also selected by the traveler, wherein the selection and ordering can occur while the customer is awaiting travel, en-route on public transportation, or preparing to disembark public transportation.

2. The method of claim 1 wherein the catalog can be made available in printed form or electronically to the electronic interface through the communications network.

3. The method of claim 1 wherein the traveler can preview available publication selections in the catalog.

4. The method of claim 1 wherein preview and selection can be provided through an electronic interfaces including at least one of a land based kiosk, on-board data communications systems or a wireless data appliance.

5. The method of claim 1, further comprising:
automatically providing the selection electronically to production facilities near the destination selected by the traveler, where at the selection is produced.

6. The method of claim 5 wherein the catalog can be made available in printed form or electronically to the electronic interface through the communications network.

7. The method of claim 5 wherein the traveler can preview available publication selections in the catalog.

8. The method of claim 5 wherein preview and selection can be provided through an electronic interfaces including at least one of a land based kiosk, on-board data communications systems or a wireless data appliance.

9. The method of claim 5, further comprising:
automatically scheduling physical distribution of the selection pick-up facilities at the destination selected by the traveler, wherein the selection is made available to the traveler through on-site distribution facilities authentication of the traveler's identity at the distribution facilities.

10. The method of claim 9 wherein the catalog can be made available in printed form or electronically to the electronic interface through the communications network.

11. The method of claim 9 wherein the traveler can preview available publication selections in the catalog.

12. The method of claim 9 wherein preview and selection can be provided through an electronic interfaces including at least one of a land based kiosk, on-board data communications systems or a wireless data appliance.

13. A method for automatically producing a publication ordered by a traveler while the traveler is en-route and having the publications ready for pick-up by traveling customers after the customer's arrival at their destination or a destination of their choosing, comprising:
receiving an electronic order for a publication over an electronic network from a traveler using a remote electronic interface;
producing the publication using publish-on-demand system located near a destination selected by the traveler for pick-up of the publication; and
distributing the publication to a pick-up facility located at the destination selected by the traveler for pick-up of the publication.

14. The method of claim 13 wherein a catalog can be made available electronically to the traveler through the remote electronic interface.

15. The method of claim 14 wherein publication preview and selection can be provided to the traveler through the electronic interface which can include at least one of a land based kiosk, on-board data communications systems or a wireless data appliance.

16. The method of claim 13 wherein the traveler can preview available publication selections in a printed catalog prior to providing an electronic order over the electronic network using the electronic interface.

17. The method of claim 13, further comprising:
providing the publication to the traveler at the destination selected for pick-up by the traveler upon authentication of at least one of the traveler's identity, a passcode or a receipt.

18. A system for automatically producing a publication ordered by a traveler while the traveler is en-route and having the publications ready for pick-up by traveling customers after the customer's arrival at their destination or a destination of their choosing, the system comprising:
a server connected to an electronic network for receiving publication orders from travelers using electronic interface for submitting orders to the server;
a database containing publications available for selection by travelers; and
at least one print-on-demand system located near pick-up destinations that can be selected by travelers for obtaining orders.

19. The system of claim 18, further comprising means for the authentication of at least one of the traveler's identity, a passcode or a receipt.

20. The system of claim 18 wherein the server is adapted for receiving order data from electronic interfaces including land based kiosks, on-board data communications systems or wireless data appliances.
